(19) United States
(12) Patent Application Publication
(10) Pub. No.: US 2011/0108584 A1
(43) Pub. Date: May 12, 2011

(54) SOLUBLE-MATERIAL CONTAINER FOR A BEVERAGE VENDING MACHINE

(75) Inventor: Dan Alexie Sirbu Villa, Bonate Sotto (IT)

(73) Assignee: N&W GLOBAL VENDING S.P.A, Valbrembo (IT)

(21) Appl. No.: 12/865,925

(22) PCT Filed: Feb. 3, 2009
(86) PCT No.: PCT/IB09/00178

§ 371 Date: Jan. 26, 2011

(30) Foreign Application Priority Data
Feb. 4, 2008 (IT) TO2008A 000083

(51) Int. Cl. G01F 11/20; B67D 7/12; B67D 3/00

(52) U.S. Cl. 222/412; 222/559; 222/522

(57) ABSTRACT

A soluble-material container for a beverage vending machine, the container having an outlet; and a spout located at the outlet and defined by a coupling body, and by a tubular body which is fitted to the coupling body, has a lateral inlet opening and an outlet opening, and is movable, with respect to the coupling body, between an open position in which the inlet opening communicates with the outlet, and a closed position closing the outlet.

### TECHNICAL FIELD

The present invention relates to a soluble-material container for a beverage vending machine.

### BACKGROUND ART

In beverage, and particularly “instant” beverage, vending machines, containers are used to store soluble material, such as instant material or sugar. Each container normally comprises a tank; and a spout fitted to the container and connected to dispensing means housed inside the tank and powered by a motor to feed metered quantities of material to the spout.

The containers are normally mounted inside the machine so they can be removed and replaced manually by an operator to fill the tanks and clean the container housing easily.

### DISCLOSURE OF INVENTION

It is an object of the present invention to provide a beverage vending machine soluble-material container that is cheap and easy to produce, and which at the same time permits fast, easy filling and cleaning by the operator.

According to the present invention, there is provided a soluble-material container for a beverage vending machine, as claimed in claim 1 and, preferably, in any one of the following Claims depending directly or indirectly on claim 1.

### BRIEF DESCRIPTION OF THE DRAWINGS

A non-limiting embodiment of the present invention will be described by way of example with reference to the accompanying drawings, in which:

FIGS. 1 and 2 show partial views in perspective, with parts removed for clarity, of a preferred embodiment of the container according to the present invention in respective different operating configurations;

FIG. 3 shows a larger-scale axial section, with parts removed for clarity, of the FIGS. 1 and 2 container in the FIG. 1 configuration;

FIG. 4 shows a larger-scale axial section of the FIGS. 1 and 2 container in the FIG. 2 configuration.

### BEST MODE FOR CARRYING OUT THE INVENTION

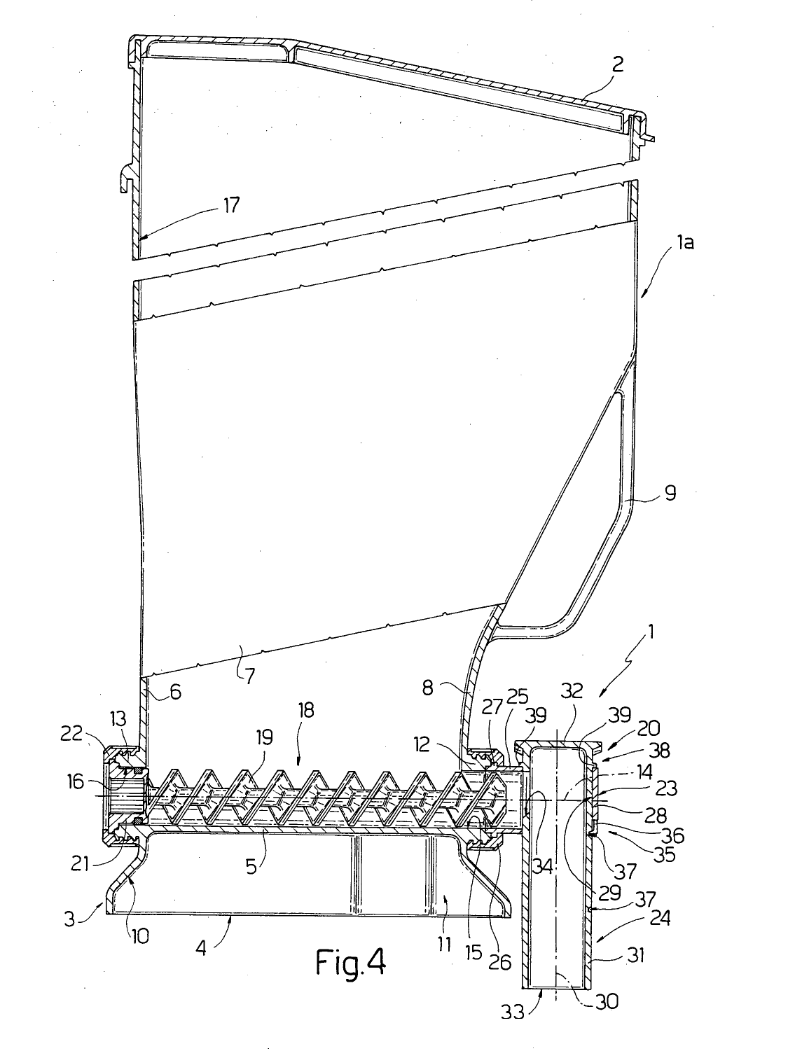

Number 1 in the accompanying drawings indicates as a whole a container comprising a tank 1a for housing soluble particulate material and closed at the top by a removable lid 2 (FIG. 4) and at the bottom by a downward-facing cup-shaped base 3. Base 3 is bounded at the bottom by an edge 4 defining a stand by which to support container 1 on a flat support not shown, and at the top by a horizontal wall 5 defining the bottom of tank 1a.

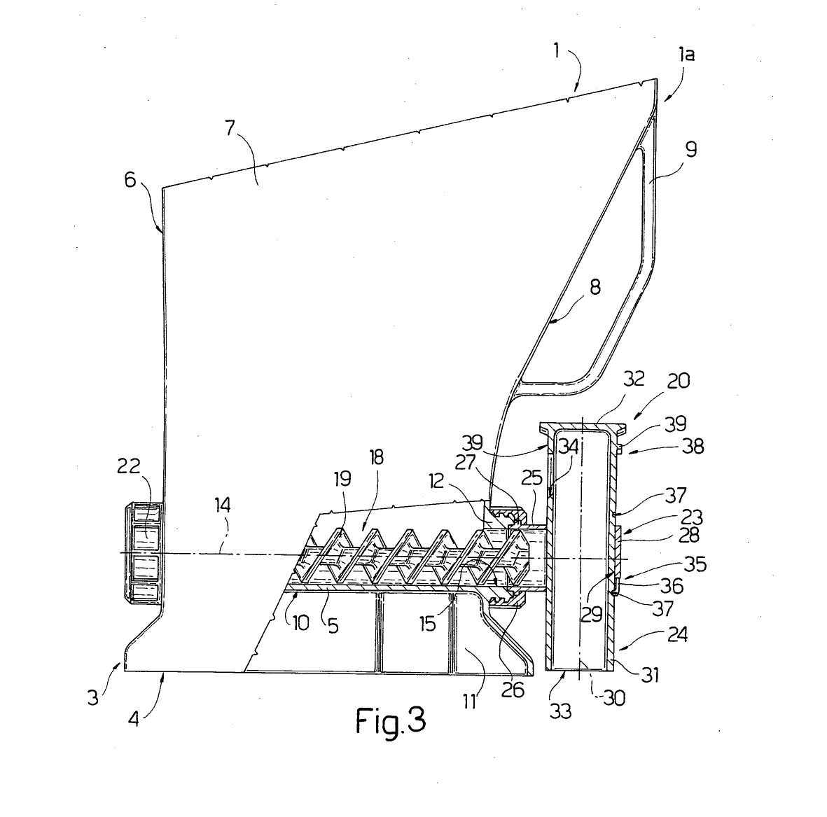

With reference to FIGS. 3 and 4, tank 1a has a substantially rectangular cross section, and is bounded laterally by a vertical rear wall 6, two parallel vertical major lateral walls 7 perpendicular to rear wall 6, and a front wall 8 substantially parallel to rear wall 6 and having an operator handgrip 9 by which to handle container 1 for filling and servicing purposes.

The cup-shaped base 3 defines a downward-open cavity 10 shaped internally to define, close to front wall 8, a straight runner 11 perpendicular to front and rear walls 8 and 6 and which is engaged in sliding manner by guide means (not shown) on said flat support (not shown) to position container 1 correctly on the flat support (not shown).

Just above wall 5, front wall 8 and rear wall 6 have respective externally threaded, tubular appendixes 12 and 13, which are coaxial along a horizontal axis 14 perpendicular to rear wall 6 and parallel to wall 5, project outwards of respective front and rear walls 8 and 6, and define respective conduits 15 and 16 connecting an inner cavity 17 of tank 1a to the outside. In addition to tank 1a, container 1 also comprises a dispenser 18 which, in use, extracts metered quantities of material from cavity 17 and comprises a powered screw 19 inside cavity 17. Finally, container 1 comprises a spout 20 located outside cavity 17 and fitted to and projecting from front wall 8 of tank 1a.

Screw 19 is defined by a two-start screw coaxial with axis 14 and fitted in rotary manner to tubular appendixes 12 and 13. More specifically, at its front end, screw 19 engages conduit 15 of tubular appendix 12 in rotary manner, and is fitted integrally, at its rear end, with a cup-shaped body 21 which is coaxial with axis 14, is knurled axially inside, engages tubular appendix 13 in rotary manner to close conduit 16 in fluidtight manner, and has, on its free end, an outer annular flange located outside tubular appendix 13 and held axially contacting a free outer edge of tubular appendix 13 by a ring nut 22 screwed onto tubular appendix 13.

Cup-shaped body 21 defines a known fast-fit face coupling by which to connect screw 19 to a rotary output member (not shown) of an actuator (not shown) for powering screw 19.

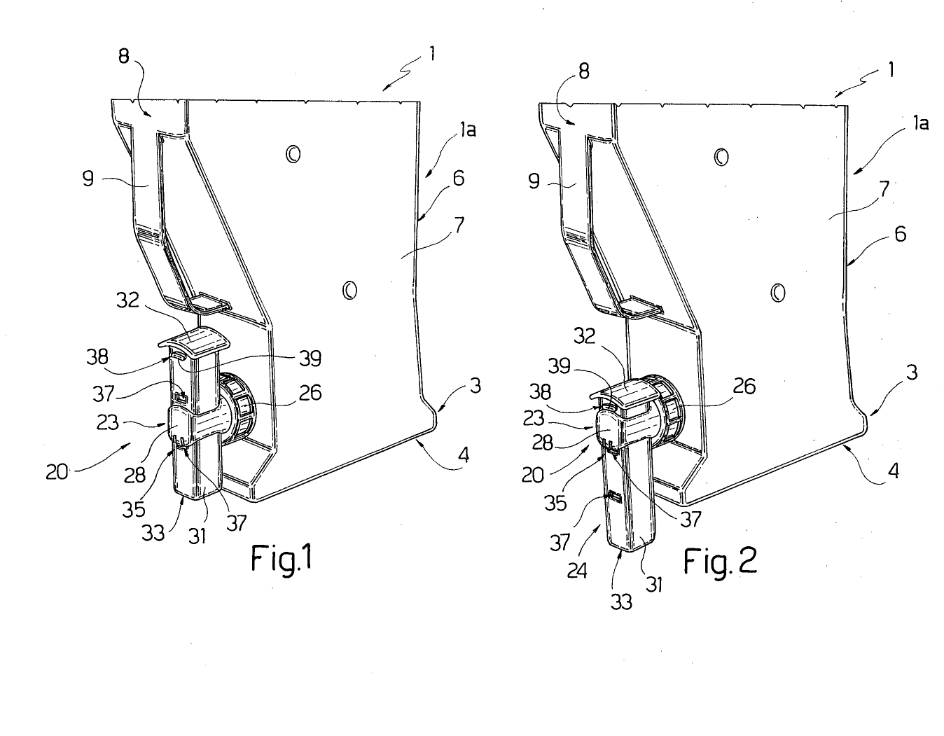

Conduit 15 of tubular appendix 12 defines an outlet conduit of tank 1a, and tubular appendix 12 defines a coupling for spout 20, which comprises a coupling body 23 for connection to tank 1a, and a dispenser body 24. Dispenser body 24 is connected to coupling body 23, and is movable, with respect to coupling body 23, between an open dispensing position (FIGS. 2 and 4), in which dispenser body 24 connects conduit 15 to the outside to expel the material from cavity 17 when screw 19 is activated, and a closed position (FIGS. 1 and 3), in which dispenser body 24 cuts off connection of conduit 15 to the outside.

Coupling body 23 comprises a sleeve 25 which supports an internally threaded ring nut 26 in rotary and axially-movable manner, has an intermediate outer flange 27 for axially locking ring nut 26, and has a free-end portion that engages conduit 15 in rotary manner, so that flange 27 contacts the free end of tubular appendix 12, to which sleeve 25 is fitted in axially-fixed and rotary manner about axis 14 by screwing ring nut 26 onto tubular appendix 12.

At the opposite end to the portion inserted inside conduit 15, sleeve 25 is fitted with an annular appendix 28 having a substantially rectangular-cross-section hole 29 with an axis 30 perpendicular to axis 14.

Dispenser body 24 comprises a tubular body 31 which extends through hole 29, coaxially with axis 30, and has a top axial end closed by a curved plate 32 coaxial with axis 14 and crosswise to axis 30.

Tubular body 31 has a material outlet opening 33 at a bottom axial end of tubular body 31; and an inlet opening 34 which is formed through the side of tubular body 31, close to plate 32 and on the side facing tank 1a, and has a flow section roughly equal to the cross section of sleeve 25.

Having a rectangular cross section similar to and roughly the same size as but no larger than that of hole 29, tubular body 31 is movable selectively, with respect to annular appendix 28 and in axially-sliding and angularly-fixed manner with respect to axis 30, into a bottom position corresponding to said open dispensing position (FIGS. 2 and 4), in which inlet opening 34 is coaxial with axis 14 and faces conduit 15, and a top position corresponding to said closed position (FIGS. 1 and 3), in which inlet opening 34 is moved upwards with respect to conduit 15, which is thus cut off from the outside by the lateral wall of tubular body 31.

Spout 20 also comprises a retaining device 35 for selectively locking dispenser body 24, with respect to coupling body 23, in the open and closed positions. Retaining device 35 comprises a tooth 36 carried by annular appendix 28; and two slots or seats 37 formed in the outer surface of tubular body 31 and into which tooth 36 clicks selectively.

Spout 20 also comprises a stop device 38 for accurately defining the open dispensing position of dispenser body 24 with respect to coupling body 23. Stop device 38 comprises two projections 39 carried by tubular body 31, close to plate 32, and which contact annular appendix 28 when tubular body 31 is pushed downwards from the closed to the open dispensing position.

As shown in FIG. 3, when dispenser body 24 is in the closed position, the whole of tubular body 31 is located above edge 4 of cup-shaped base 3 of tank 1a, in a position clear of the flat support (not shown) possibly underneath, so container 1 can be moved, if necessary, with respect to the flat support (not shown) with no risk of material spillage.

In other words, in spout 20, annular appendix 28 and tubular body 31 define a yes/no tubular slide valve, in which tubular body 31 defines the tubular valve, and annular appendix 28 defines the slide; and spout 20 not only allows the material from tank 1a to be directed in any radial direction with respect to axis 14, but also serves as a tap to control outflow of the material from conduit 15.

1. A soluble-material container for a beverage vending machine, the container comprising:
a tank with an outlet; and
a spout fitted to the tank at the outlet, wherein the spout comprises,
a coupling body for connection to the tank; and
a tubular body which is fitted to the coupling body, has an inlet opening and an outlet opening, and is movable, with respect to the coupling body, to and from an open material dispensing position in which the inlet opening communicates with the outlet of the tank via the coupling body.

2. The container as claimed in claim 1, wherein the spout is fitted to and projects from the tank at the outlet.

3. The container as claimed in claim 1, wherein the inlet opening is an opening formed in a side of the tubular body.

4. The container as claimed in claim 1, wherein the outlet opening is an axial end opening of the tubular body.

5. The container as claimed in claim 1, wherein the outlet has a first axis, and the tubular body has a second axis substantially perpendicular to the first axis.

6. The container as claimed in claim 5, wherein the coupling body is mounted to rotate about the first axis.

7. The container as claimed in claim 5, wherein the tubular body rotates with the coupling body about the first axis.

8. The container as claimed in claim 1, wherein the tubular body is movable axially with respect to the coupling body.

9. The container as claimed in claim 5, wherein the tubular body is angularly fixed with respect to the second axis.

10. The container as claimed in claim 1, wherein the outlet has a first axis, and the tubular body has a second axis; the coupling body comprises an annular portion coaxial with the second axis; and the tubular body extends through the annular portion.

11. The container as claimed in claim 1, wherein the inlet opening is formed in a side of the tubular body; and the tubular body is movable between a open position in which the inlet opening faces the outlet, and a closed position in which a portion of the tubular body faces the outlet to close the outlet.

12. The container as claimed in claim 11, wherein the spout comprises releasable retaining means interposed between the coupling body and the tubular body to selectively lock the tubular body, with respect to the coupling body, in the open and closed positions.

13. The container as claimed in claim 12, wherein said retaining means comprise a tooth integral with the coupling body; and first and second seats formed in the tubular body, and into which the tooth selectively clicks when the tubular body is in the open position and the closed position respectively.

14. The container as claimed in claim 11, further comprising stop means configured to arrest the tubular body with respect to the coupling body in said open position.

15. The container as claimed in claim 1, wherein the outlet is defined by an externally threaded tubular appendix extending from the tank; the coupling body being fitted to the tubular appendix, and being fixed axially with respect to the tubular appendix by a threaded ring nut.

16. The container as claimed in claim 15, further comprising a dispenser housed inside the tank to extract metered quantities of material from the tank in use; and wherein the tank has first and second tubular appendices, of which the first appendix defines the outlet, and the second appendix is coaxial with the first appendix and with the coupling body; the first and second tubular appendices supporting the dispenser.

17. The container as claimed in claim 16, wherein the dispenser comprises a powered screw supported in rotary manner by the first and second tubular appendices.

18. The container as claimed in claim 17, wherein the screw is defined by a two-start screw.

19. The container as claimed in claim 17, wherein the screw is fitted integrally at one end with fast-fit connecting means for its own connection to rotary actuating means.
